(19) United States
(12) Patent Application Publication
(10) Pub. No.: US 2009/0007245 A1
(43) Pub. Date: Jan. 1, 2009

(54) SYSTEM AND METHOD FOR CONTROLLED CONTENT ACCESS ON MOBILE DEVICES

(76) Inventor: Michael J. Schultz, San Jose, CA (US)

Correspondence Address: PERKINS COIE LLP, P.O. BOX 1208, SEATTLE, WA, 98111-1208, US

(21) Appl. No.: 12/167,188

(22) Filed: Jul. 2, 2008

Related U.S. Application Data
(63) Continuation-in-part of application No. 11/673,490, filed on Feb. 9, 2007.
Application No. 11/673,490 is a continuation-in-part of application No. 12/142,727, filed on Jun. 19, 2008.

(51) Int. Cl. H04L 9/32; G06F 21/00; G06F 17/30

(52) U.S. Cl. 726/5; 707/104.1; 707/E17.044

(57) ABSTRACT

A new approach enables a carrier, a validated user or a parent/guardian of the user to effectively moderate content displayed one a mobile device and navigates the web without the need to input URL addresses through the use of an integrated instant messenger/web browser operating on the mobile device. First, the identity of the user is validated when he/she is initiating access to instant messaging and/or web browsing. In the case where the user is an under-aged child, the identity of the user can be validated by his/her parent or legal guardian or principal of the school the child is attending. Once validated, the user can access and select from a set of websites that have been pre-selected or pre-approved for the user by the carrier, user, and in some cases parent or guardian of the user for easy and secure web browsing by the user on the mobile device.

### RELATED APPLICATIONS

This application is a continuation in part and claims priority to U.S. patent application Ser. No. 11/673,490, filed Feb. 9, 2007, (Our Docket No. 64283-8001), and entitled “Integrated Instant Messaging and Web Browsing Client and Related Methods” by Shaun Marsh et al., and is hereby incorporated herein by reference.

This application is a continuation in part and claims priority to U.S. patent application Ser. No. 12/142,727, filed Jun. 19, 2008, (Our Docket No. 64283-8006 US01), and entitled “System and Method for Password-Free Access for Validated Users” by Michael J. Schultz, and is hereby incorporated herein by reference.

### BACKGROUND

In the last two decades, the deployment and use of mobile computing devices has grown such that a large percentage of people living in the United States, Europe, Asia, and other places have a least one device. Mobile phones, personal digital assistant's (PDAs), laptop computers and a host of similar devices are carried by people world wide as computer and connectivity devices. At the same time, advancements in microprocessor technology and in communications protocol have provided many tools that are included in addition to the basic functions of the mobile devices. For example, mobile phones are equipped with games, address books, instant messaging systems, and web browsing system.

To minimize the size of these mobile devices, extend the operating time (limited by batteries) and make them not only more attractive to carry, and other considerations, the computing capabilities as well as the display area (screen) of the mobile devices are necessarily limited. The input mechanisms are often limited when compared to more traditional computing systems. These include numeric keypads on phones and keyboards operated by thumb in a “hunt and peck” method. More advanced PDA's have touch screens for input and output. These factors contribute to often cumbersome switching between application programs. Special applications are devised to provide functions and services such as instant messaging, email, and web browsing to compensate for the deficiencies. The mobile applications have been devised following the model used on the larger fixed based predecessor; the familiar computer. The application model in combination with limitations of the mobile platform has resulted in mobile software programs that allow users to execute one program at any given time with little or no visibility into the activities of other important programs executing concurrently. For instance, the user may be browsing the web or viewing a newly arrived instant message, but not simultaneously. These systems all suffer more or less equally from difficulty knowing when to switch between applications.

Web browsers comprise a class of software applications for transmitting data to-and-from server computers, as well as rendering documents returned by those computers on the display of a local computer. A web browser enables a user to display and interact with instant, images, and other information typically located on a web page at a website on the World Wide Web or a local area network. Similarly, a microbrowser (sometimes minibrowser or mobile browser) is a web browser designed for use on a handheld device such as a PDA or mobile phone. Microbrowsers are optimized so as to display internet content most effectively for small screens on portable devices and have small file sizes to accommodate the low memory capacity and low-bandwidth of wireless handheld devices. On the other hand, instance messaging client applications (instant messengers) comprise a class of software applications for transmitting instant messages from one person to another over a computer or telephony network.

Mobile browsers and instant messengers are currently deployed on most, if not all, mobile devices used today and are considered common features on all mobile devices currently being manufactured. Increasingly, consumers are using their mobile devices are the primary means of contact and not via voice by data transmissions such as Short Messaging Service (SMS), Instant Messages (IM), and web-based portal access.

Today wireless service providers, also known as carriers, moderate access to content via mobile browsers with the use of a blacklist that designates websites that are unsuitable for a particular demographic primarily such as underage children. This type of content moderation is limited to preventing access to sites banned by the carrier and must be updated on a frequent basis to keep the blacklist current. Given the fact that hundreds of new websites each month are started, it is extremely difficult to make any blacklist 100% effective as a means to moderate content access.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is block diagram of an embodiment of the present disclosure showing in the interrelationship of the various components of the present disclosure.

FIG. 2 is a block diagram of an embodiment of a display and control module of the present disclosure.

FIG. 3A is a perspective view of an embodiment of mobile device having the integrated instant messaging and web browser system.

FIG. 3B is a perspective view of an embodiment of mobile device having the integrated instant messaging and web browser system.

FIG. 4 is a flow chart of an embodiment of a method of offering internet content over a network.

FIG. 5 depicts an example of browsing through pre-selected websites for a user who has interest in sports, specifically soccer and with a particular emphasis on a specific soccer team.

FIG. 6 depicts a flowchart of an example of a process to support controlled content access on mobile devices.

### DETAILED DESCRIPTION OF EMBODIMENTS

The specific embodiments described in this document represent examples or embodiments of the present invention, and are illustrative in nature rather than restrictive. In the following description, for purposes of explanation, numerous specific details are set forth in order to provide a thorough understanding of the invention. It will be apparent, however, to one skilled in the art that the invention can be practiced without these specific details.

Reference in the specification to “one embodiment” or “an embodiment” or “some embodiments” means that a particular feature, structure, or characteristic described in connection with the embodiment is included in at least one embodiment of the invention. Features and aspects of various embodiments may be integrated into other embodiments, and embodiments illustrated in this document may be implemented without all of the features or aspects illustrated or described.

A novel system/method is devised to provide functionality for users connected to mobile communication networks, such as a cellular phone networks. Disclosed is an instant messaging platform having an integrated web browser for Internet content. The system also comprises a display and control module, which provides the user interface for the dual instant messaging and web browsing sub-systems. Users are informed when an instant message has arrived and may discover who sent the message and the message content without the need to switch applications. In this system, users can easily move back-and-forth between instant messaging and web browsing activities using the user interface without the need to select and open a new program application on their mobile devices.

Furthermore, through the use of the integrated instant messenger/web browser, the identity of a user can first be validated when he/she is initiating access (logging) to instant messaging and/or web browsing. In the case where the user is an under-aged child, the identity of the user can be validated by his/her parent or legal guardian or principal of the school the child is attending. Once validated, the user can then access and select from a set of websites via the integrated mini-browser that displays the websites to the user. Here, the set of websites have been pre-selected or pre-approved by the carrier, user, and in some cases parent or guardian of the user for easy and secure web browsing by the user on the mobile device. As used in the present disclosure, the term “validation” or “verification” shall be defined as confirmation of an identity of a user.

Through the use of an integrated Instant Messenger/Browser, a carrier, a validated user or a parent/guardian of the user can effectively moderate content displayed on a mobile device and also navigate the web easily without the need to input arcane URL addresses as everything is designed as a click through process. The validated user is able to browse only the web content of his/her interest and choosing instead of searching all over the web given the limited display area of a mobile device. Parents and guardians can make sure that their children's safety on the internet, as pre-approved websites blocks offensive or dangerous website to children. In the meantime, communication companies can increase revenues via pre-approved fee-paying websites prior to their being made available to users online.

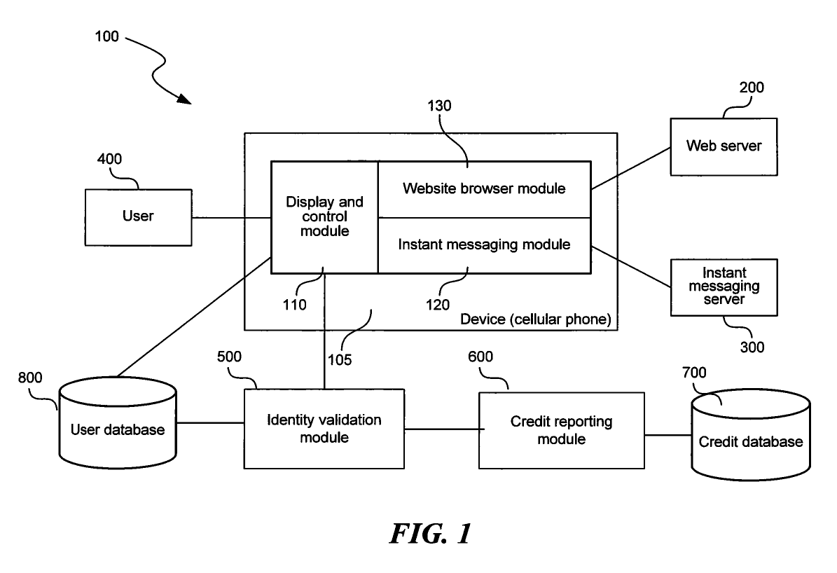

According to embodiments shown in FIG. 1, mobile device 100 is shown having integrated instant messaging and web browsing system (application software) 105. Mobile device 100 is, according to embodiments, a mobile phone, personal digital assistant (PDA), other embedded devices, and the like. According to other embodiments, mobile device 100 may comprise a mobile computer. Artisans will recognize that although the principles of the present disclosure are couched in terms of mobile computing, the same principles are applicable to nearly any device capable of executing machine readable instructions.

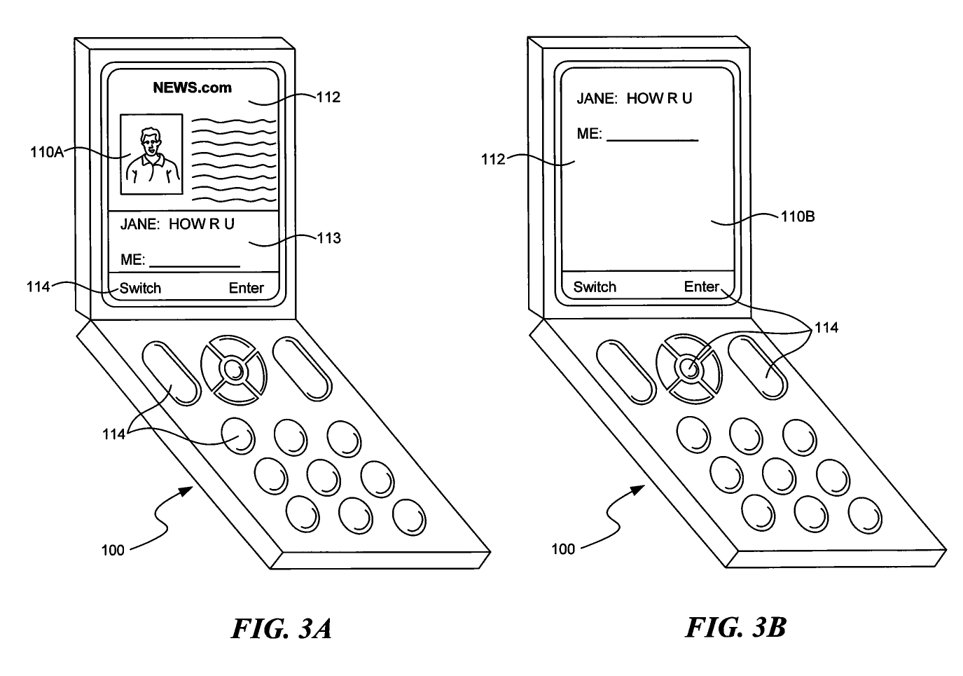

Accordingly, integrated instant messaging and web browsing system 105 integrates both web browsing module 130, which provides a platform for viewing web content (websites) from the internet, and instant messaging module 120, which provides a platform for sending and receiving instant messages, into a single application. Instant messages may be any short message sent from a device to another device over a network. Integrated instant messaging and web browsing system 105 provides display and control module 110 to users 400 that allow users 400 to easily switch between instant messaging module 120 and web browsing module 130 (as shown in FIGS. 3A and 3B) and display web browsing module 130, instant messaging module 120, or both on the screen of mobile device 100.

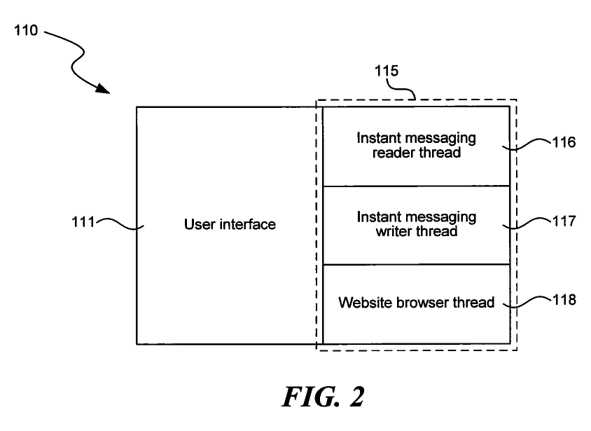

According to embodiments, for example as shown in FIG. 2, display and control module 110 manages all user interaction from a mobile device's input mechanism, such as the keypad of a mobile phone, manages separate threads of activities of integrated instant messaging and browsing system 105, including website browsing and instant messaging activities that may be executing in parallel, and displays content on the screen of mobile device 100. As shown according to the embodiment of FIG. 2, display and control module 110 comprises user interface 111 and background threads 115.

User interface 111 comprises a thread that captures inputs from user 400 and renders outputs from several background threads 115 executing in parallel, according to embodiments. User interface 111 comprises the following components: main window module 112, message bar 113, and input mechanisms and menu buttons module 114.

According to embodiments, main window module 112 renders the primary content selected by user 400 on a display. It may comprise rendering a web page on the display, an instant messaging dialog that is currently in progress on the display, or a system menu, according to embodiments. Similarly according to embodiments, main window module 112 displays instant messages and web browser content simultaneously (in parallel). Artisans will understand how to implement an appropriate output to a display without undue experimentation.

Likewise according to embodiments, message bar 113 conveys messages to user 400, including the arrival of new instant messaging messages, for example. According to embodiments, message bar 113 is super-imposed over the content of main window module 112 that is being displayed for a brief time while the message is conveyed to the user. According to similar embodiments, message bar 113 may occupy a portion of the display permanently, until cleared, or for a short period of time. The other contents of the display will be shifted around the portion of the display having message bar 113. According to still other embodiments, message bar 113 is “ticker tape”-type banner that occupies a relatively small portion of the display and provides user 400 with instant messaging alerts, such as an instant message received, or other messages from integrated instant messaging and browsing system 105 or mobile device 100. Accordingly, in some embodiments, user 400 will be able to choose the desired behavior of message bar 113 as a modifiable setting. According to embodiments, message bar 113 may also display a notification when each web page has completed downloading and rendering and is ready to be viewed.

According to embodiments, input mechanisms and menu buttons module 114 allow user to interact with display and control module 110. They form a set of commands and inputs that are interpreted when the user activates specific input mechanisms on mobile device 100. According to embodiments, input mechanisms are buttons, thumb wheels, touch pads, touch screens, and other input mechanisms for mobile devices and non-mobile devices. Moreover, input mechanisms and menu buttons module 114 map commands to corresponding input mechanisms on a device. For example and as shown in FIG. 3A and FIG. 3B, the “Switch” and “Enter” commands are mapped to the buttons that they reside in closest proximity with. Another example is the input of text from the number pad of a cellular phone. Similarly, for example, menu items are navigated with arrow keys; as each menu option is navigated to with the arrow keys, it is highlighted. Pressing an “Enter” or “OK” button will send a command to select the highlighted option. Artisans will known and understand the many variations of mapping input mechanisms with commands and inputs.

Input from input mechanisms and menu buttons module 114 is interpreted based on the type of content in main window 112, according to embodiments. For example and according to embodiments, a down-arrow on mobile device 100 does not have a function (associated command to execute) when main window 112 is rendering an instant messaging dialog. However, it moves a logical cursor when main window 112 is rendering a system menu or a web page with links. Thus, input mechanisms and menu buttons module 114 may be context sensitive, depending on the thread or threads being shown on the display, according to embodiments.

Typically, for example, user 400 may be viewing a web page within main window 112 and receive a new instant messaging message, which is indicated to the user via message bar 113. User 400 may then continue with web browsing in main window 112 or execute a command using input mechanisms and menu buttons module 114 to switch to a revised main window 112 showing the instant messaging dialog and allow user 400 to engage in a conversation with another user.

Background threads 115, operating in parallel, comprise instant messaging reader thread 117, instant messenger writer thread 117, and web browser thread 118. Instant messaging reader thread 117 invokes instant messaging module 120 with instructions to accept messages sent by instant messaging server 300, according to embodiments. Similarly, instant messenger reader thread 117 interacts with user interface 111 to display incoming instant messages, according to embodiments. For example, instant messenger reader thread 117 causes message bar 113 to alert user 400 that a new instant message has arrived if content displayed by main window module 112 is displaying web pages; if the content displayed by main window module 112 is instant messaging, then instant messenger reader thread 117 causes the incoming message to be accordingly displayed.

According to embodiments, instant messaging writer thread 117 invokes the instant messaging module 120 with instructions to send messages to messaging server 300. Instant messaging writer thread 117 is invoked, according to embodiments, when user 400 activates input mechanisms and menu buttons module 114 with one or more commands wherein text is entered and a command indicating that the text that has been entered and is ready to pass to instant messaging module 120.

According to embodiments, web browser thread 118 invokes web browser module with instructions to request a specific web-based service and then caches (stores) the reply results. Web browser thread 118 also interacts with user interface 111 to both display stored web pages and receive input from user 400 directing instant messaging and web browsing system 105 to the webpages to be viewed. According to embodiments, users may directly input uniform resource indicator (URI) addresses to access specific webpages or may select webpages from a menu.

Each of instant messaging reader thread 117, instant messaging writer thread 117, web browser thread 118, and user interface 111 occur in parallel: instant messaging messages may be sent, instant messaging messages may be received, and web pages may be requested and cached for rendering simultaneously within the confines of a single program application, according to embodiments. Because each thread operates in parallel with the other threads, instant messaging messages, for instance, are received within instant messaging reader thread 117 while user 400 is making web page requests within the web browser thread 118.

According to embodiments, an internal application-programming interface (API)/callback mechanism is used to alert user interface 111 when one or more background threads 115 have performed an activity that requires rendering either in main window 112 or in message bar 113. According to embodiments, when instant message reader thread 117 receives a message, it calls the API within user interface 111, and then user interface 111 conveys that message in message bar 113. The other features are similarly communicated between the various modules, threads, and interfaces of the present disclosure.

Multiple web browser threads 118 may be invoked in parallel, according to embodiments. For example, user interface 111 may render one web page, the result of one thread, and then render the next web page, the result of another thread, as per user's 400 request as indicated by user 400 using input mechanisms and menu buttons module 114. According to embodiments, each web browser thread 118 comprises a main window module 112 content set; thus, user may use a “Switch” function to browse each individual display page of content much like opening individual web browser windows in traditional computing platforms.

FIGS. 3A and 3B show mobile device 100 in two iterations. Display and control module 110A is configured to show both a webpage and an instant messaging area on the screen of mobile device 100. According to embodiments, user 400 may switch between various displays by activating a “Switch” command, for example. Pressing it once will “close” integrated web browser module 130 (shown as 110B). Artisans will recognize that as web browsing module 130 and instant messaging module 120 are part of a single program application, according to embodiments, “closing” integrated web browser module 130 or instant messaging module 120 merely causes the screen to display only web browser module 130 or instant messaging module 120 depending at the time the input is activated. The “closed” module remains available and will continue to operate in the background. Thus, a web page may be selected and web browser module 130 will load the webpage, even if the web browser module 130 screen is “closed” and instant messaging module 120 screen is activated. According to embodiments, a percentage of a screen may be devoted to web browsing module 130 and a percentage of a screen may simultaneously display instant messaging module (shown as 110A in FIG. 3).

According to embodiments, display and control module 110A also provides an integrated method of switching between instant messaging mode, as shown as a tool bar at the bottom of the screen with commands “Switch” and “Enter” corresponding with two keypad buttons on mobile device 100. Artisans will recognize that other commands may be mapped to a tool bar, according to embodiments. According to other embodiments, toolbar will be omitted to conserve screen space and users 400 must learn which commands correspond to which buttons on their respective input devices.

According to embodiments, web browser module 130 manages all interaction with external web servers 200 and assists display and control module 110 when rendering materials is returned by those web servers 200.

Likewise according to embodiments, instant messaging module 120 manages all interaction with external instant messaging servers 300 and assists display and control module 110 when rendering messages returned by those instant messaging servers 300.

Web browser module 130 and instant messaging module 120 operate in parallel, according to embodiments, so network messages may be received while websites are being browsed. Display and control module 110 may display materials received by web server 200, messages received by instant messaging server 300, or a combination of both types of materials if both types of materials are be received in parallel.

Communications between user 400 and the display of display and control module 110 is performed through the physical interface provided by mobile device 100. For a cellular telephone, for example, this comprises a display screen, keypad, and other input mechanisms built into the telephone. Similarly, for PDAs may comprise a screen, keyboard and other buttons, thumbwheel, touch screen, or combinations thereof. Depending on the device, artisans will recognize the applicable input mechanisms that may be employed to operate the systems and methods of the present disclosure.

According to embodiments, the display and control module 110 can request information of user 400 for identity validation purposes before the user 400 is allowed to login to instant messaging module 120 or access websites via website browser module 130. To this end, the display and control module 110 may request certain personal data of the user, which may include but is not limited to, name, address, telephone number, e-mail address, etc., and provides such information to the validation module 500 to verify the user's identity.

According to embodiments, the display and control module 110 may request for additional information of user 400 if user 400 is a child/minor under the legal age. Such information may include but is not limited to, name, date of birth, school address, telephone number, and/or name of parent(s) and/or school principal. Such information can then be forwarded to the parent/legal guardian and/or school principle by e-mail, short message alert, or fax. The user's access to the instant messenger is only granted when the identity of the child who is trying to access is verified by the parent/guardian or school principal. Additionally, the child's access can be granted only when the parent/guardian is able to oversee and monitor his/her online activities either locally or remotely.

According to embodiments, identity validation module 500 validates the identity of the user upon the request of the display and control module 110. More specifically, the identity validation module 500 is given certain information of user 400 from the display and control module 110 that is requesting the identity validation. The display and control module 110 then provides such information to credit reporting module 600 either individually or as a batch, which provides a set of Knowledge Based Authentication (KBA) questions in return. Here, the set of KBA questions are generated by the credit reporting module 600 based on credit profile of user 400 retrieved from credit database 700. These questions are generally “out of wallet” type questions that do not contain personally identifying information of the user and are not related to the person's credit cards, personal data used to identify them, or commonly known information of the user. Currently, information from the user's credit files has been used to authorize access to online accounts for credit file reporting (e.g., Experian at creditexpert.com) or for lost account passwords with a credit card issuer (e.g., Chase at chase.com). However, such information has not been utilized for online identity validation.

According to embodiments, the credit reporting module 600 performs a reverse lookup for the user's social security number using the user's information provided by the identity validation module 500. Based on the user's social security number, the credit reporting module 600 is able to retrieve the user's profile and/or credit history from the credit database 700, and generates a set of KBA questions that are specifically tailored based on the user's profile and/or credit history. For non-limiting examples, the set of KBA questions may include but are not limited to, a specific transaction on a specific date, the location of a recent transaction, prior addresses or phone numbers, etc. Once the user's responses to the set of KBA questions are retrieved and provided to the credit reporting module 600 by the identity validation module 500, the credit reporting module 600 may rate or grade the responses and provide the grading back to the identity validation module 500.

According to embodiments, the credit database 700 coupled to the credit reporting module 600 can include both public and/or private databases. The database 700 is operable to store and manage identity, profile, and/or credit history of user 400, wherein such information may include but is not limited to, credit scores, transaction history, reported incidents or issues regarding previous transactions made by the user. In addition, the database may also contain KBA questions and answers or the database may be used to generate KBA questions and answers tailored to the user's credit and/or transaction history. Here, the term database is used broadly to include any known or convenient means for storing data, whether centralized or distributed, relational or otherwise. Due to their sensitive nature, records in the credit database 700 should be highly secured and optionally encrypted. Such record can be indexed and be made searchable via any of the information of the user, such as credit card number, social security number, name, or telephone number upon request. In one embodiment, the KBA questions do not contain personally identifying information, but rather person-specific information, and therefore does not compromise the security of the credit reporting module 600 or database 700 or the user's identity. In one embodiment, the selection of KBA questions to ask user 400 varies from one transaction to another, thereby limiting the potential damage if the KBA questions and their answers are somehow intercepted or otherwise compromised. In one environment, sensitive personally identifying information, such as social security number, are not disclosed by the credit reporting module 600, but rather are used internally to generate KBA questions and answers, which are much less sensitive that the personally identifying information.

According to embodiments, the identity validation module 500 provides the set of KBA questions to user 400 once the questions are generated via the display and control module 110, which, at least in some embodiments, may then present (e.g., display or speak via computer generated voice) the KBA questions automatically to user 400 for validation of the user's identity. Alternatively, the KBA questions may be submitted to the user through a different device than used for providing the web service, for a non-limiting example, the user's cellular phone or an email device. In some embodiments, the identity validation module 500 may directly provide the KBA questions to user 400 and receive responses without using the instant messaging module 120 as an intermediary.

According to embodiments, the identity validation module 500 retrieves the responses to the KBA questions from the user, if such responses are provided in a timely manner, for the credit reporting module 600 to review. For example, user 400 has a timed window to correctly reply to the questions after which they are graded for accuracy or the validity of his/her identity will be denied by the identity validation module 500. The window can be measured in minutes, to avoid the user from “looking up” the answers to the KBA questions by referencing to other sources, such as the actual credit report from which the KBA questions are generated.

According to embodiments, the validation module 500 will decline to confirm the identity of user 400 if validation is not completed within an allotted time span (such as due to slow response by the user) or is denied because the rating/grading of the responses to the KBA questions by the credit reporting module 600 is negative. Consequently, the display and control module 110 will be alerted of a potential identity theft and the access request initiated by the user to the instant messaging module 120 will be declined. If the rating of the responses to the questions by the user is positive (and preferably, timely), the identity validation module 500 will notify the display and control module 110 that the user's identity has been verified.

According to embodiments, the identity validation module 500 allows user 400 to register securely via the instant messaging module 120 once the identity of user 400 is validated. In addition to providing his/her personal information and creating his/her username as part of the user's profile during the registration, the user may be asked to create a series of personalized challenge questions (PCQs) based on his/her personal life experiences and provide his/her personalized answers to them. Unlike KBAs, PCQs are not related to the credit history or profile of the user. Rather, PCQs are based on the personal life of the user that only the user him/herself knows the answers, thus are highly confidential while the user does not need to remember the answers to them. These PCQs can be rotated and randomly chosen to maintain sufficient barriers to identity cloning or phreaking.

According to embodiments, the validation module 500 will associate the PCQs and their answers rest of the user's profile including his/her username provided during registration and save them in user database 800 or in a local database of the validation module 500. Here, the answers to the PCQs are unique as they are based on the real events happened in the user's personal life. The next time when user 400 initiates a subsequent access to instant messaging module 120 and/or website browser module 130, the validated user 400 will be prompted to enter his/her username. Instead of being asked for the PIN or password associated with the username, however, user 400 will be asked one or more of the PCQs randomly picked from the set of PCQs the user created during registration. The display and control module 110 will accept the answers to the randomly picked PCQs by the users, and the validation module 500 retrieves answers to the PCQs previously saved in the user database 800 and compares them to the answers currently provided by the user. If the answers to the PCQs match, the user's request for access will be granted. Otherwise, the user's access will be denied just as when the user fails to provide a correct PIN/password.

In some embodiments, the validation module 500 may utilize an interactive voice response (IVR) system for the identity validation process. The user may be required to register his/her voice in a database for validation purposes. In some embodiments, the user may be required to “voice print” him/herself multiple times. Then the user is required to answer the KBA and/or PCQ questions during validation and the validation module 500 will match the voice with the voice print stored with the user's profile stored in the user database 800. The user's identity is validated only when a match between the voices is found.

The identity validation module 500 adds an extra later of user identity management and protection to integrated instant messaging and browsing system 105, by utilizing KBAs for initial user identity validation and PCQs for subsequent password-free access by a validated user without prompting the user for PIN or password. Such a combined KBA and PCQ approach can effectively address at least the following four issues for identity management and protection:
Authentication of the user trying to access the IM/web content provided, by validating the user's identity first through the use of KBAs and later through the use of PCQs.
Authorization of web content the user is allowed to access, by granting the web service only to that particular validated user.
Administration of services provided, by setting rule to allow only validated users to contact other validated users and how such contacts can be made.
Audition of web content provided, by keeping records of requests and access to the IM/web content by the user in the user database 800, which can be secure encrypted. Compliance with security can be confirmed by keeping an audit trail of when and by whom access was made, what validation efforts were made and successful as well as when unauthorized access has been attempted.

Once the identity of user 400 is verified, he/she is allowed to not only login and use the instant messenger, but to browse selected web content via the integrated web browser. Here, such website can be one or more of:
Pre-selected by user 400 based on his/her interests once his/her identity is validated.
Pre-approved by the parent or legal guardian if user 400 is a child/minor, as being safe and/or educational for children.
Pre-approved by the mobile communications companies (carrier) for the IM or internet service of these websites that are willing to pay a fee to the carrier to have their content presented or featured to users 400 of the carrier's services.
   Note that these categories of websites are not mutually exclusive as

According to embodiments, wireless communications companies (carriers) for the mobile device may employ the use of a software suite, such as integrated instant messaging and web browsing system 105 disclosed herein. The mobile communications company allows the validated user 400 to access only websites pre-approved by the mobile communications company. Accordingly, by limiting user's access to only pre-approved web content, mobile communications companies may provide a value added to parent and guardians who are worried about the content their children view on the internet. Moreover, according to embodiments, by making the list of pre-approved website available to parents and guardians, the parents and guardians may know exactly what content is viewable on children's mobile communications devices.

Similarly and according to embodiments, mobile communications companies may earn revenue by pre-approving only websites that subscribe to the mobile communications companies' approval list. For example, ACME.com may offer child friendly content of cartoon episode recaps. ACME.com would be attractive and safe for children to view, which would make ACME.com eligible to be included in the pre-approved websites available to children. However, the mobile communications company would not include ACME.com until ACME.com paid a set price to be listed and available to subscribers of the mobile communications network.

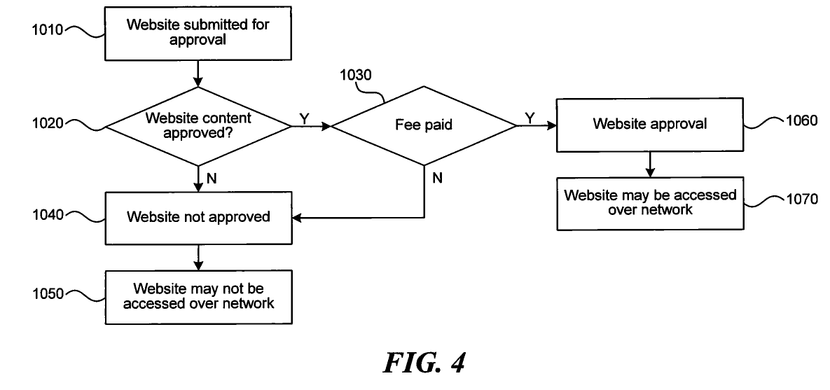

FIG. 4 is a flow chart of an embodiment of a method of offering internet content over a network by wireless communications companies. According to an embodiment, a website is submitted to an entity having a network with which mobile device can communicate 1010. The first step, according to an embodiment, is a process of screening the content of the website 1020. After the content is found to be non-objectionable, the website must pay a fee to the entity having a network 1030. The fee payment and content approval steps may be juxtaposed according to embodiments. According to still other embodiments, the step requiring payment of a fee 1030 is optional and may be omitted from the method. If either the content is not approved or a fee is not paid, the website is not approved 1040 and users of the network will be unable to access the website 1050. Conversely, it the website is approved 1060, users of the network will be able access the website via the network and view the contents of the website 1070.

According to embodiments, display and control module 110 provides a pre-approved/pre-selected website list on the user's mobile device that is compatible with a given network on web browser module 130. Thus, users 400 would not be able to directly type in URI and view the content of the URI, but would rather select an available website from a pre-existing/pre-defined list built into the software. To that end, according to embodiments, websites may be sorted by mobile communications companies according to the subscription fee paid by the website to make those that paid a higher subscription fee more visible to subscribers to the mobile communication company's network. Alternatively, the websites may be pre-selected and sorted by user 400 and/or his/her parent/guardian based on their personal interests and concerns.

According to embodiments, display and control module 110 is configurable to ensure that user 400 may only request specific web sites. If this configuration has been employed, then display and control module 110 will only allow those specific web server addresses to be passed to the web browser module 130. Thus, according to embodiments integrated instant messaging and browsing system 105 provides a platform in which responsible parties for mobile device 100 may filter content viewed by users 400. Moreover according to embodiments, mobile communications companies may contract with web sites to provide their website to users 400 of the mobile communications company via integrated instant messaging and web browser system 105, providing an additional source of revenue to the mobile communications company.

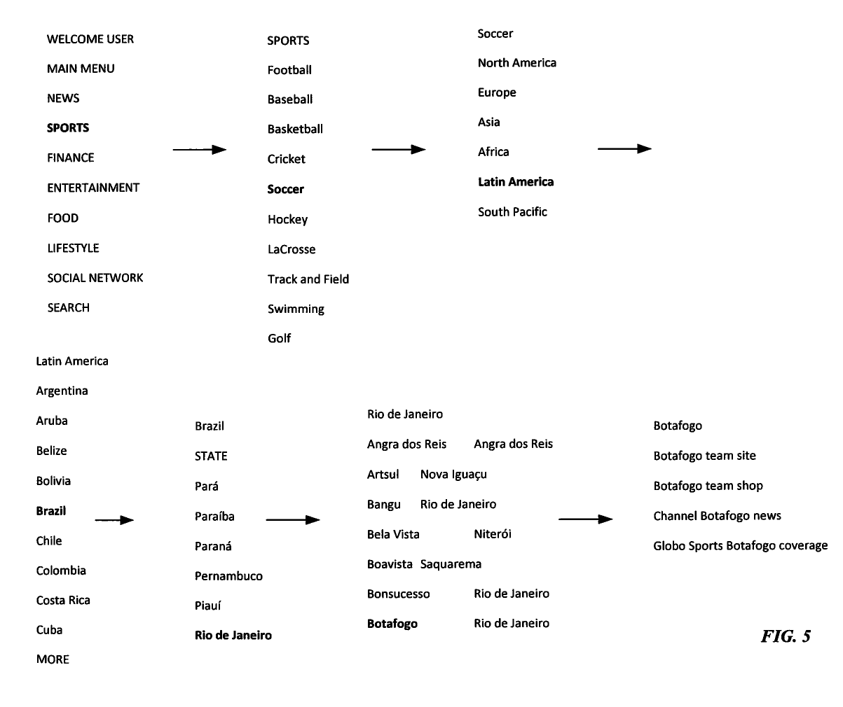

According to still similar embodiments, available websites are organized and categorized (e.g., news, sports, children's, television, etc.) into one or more pre-defined menus. Thus, users 400 navigate to a website after navigating to a specific category from one or more embedded “click through” menus. FIG. 5 depicts an example of browsing through pre-selected websites for user 400 who has interest in sports, specifically soccer and with a particular emphasis on the soccer team Botafogo of Rio de Janeiro. Once user 400 has validated themselves, he/she can click through the general “Sports” tab from the main menu of selected categories of web content, select “Soccer” from “Sports” menu, select “Latin America” from “Soccer” menu, select “Brazil” from “Latin America” menu, select “Rio de Janeiro” from “Brazil STATE” menu, and finally select “Botafogo” from “Rio de Janeiro” menu and be presented with a set of websites that are related to Botafogo, the soccer league they play in and the languages available for information or news on the team Botafogo as shown.

According to embodiments, display and control module 110 allows user to create and select a profile to access to one or more websites of the user's interest. By the use of “click through” menus, user 400 can navigate to the precise site or sites he/she wish to visit in the future and save the site(s) to a custom profile which user 400 can personalize and name, for example, as “Botafogo” in FIG. 5. That profile can be saved in user database 800 and be added to the main menu presented to the user 400 so that the user can switch the general menu to only those sites they have previously selected. Such profile creation process can be made over and over again with different main themes and websites. In the case of carrier-driven site selection only those sites permitted by the carrier are available for selection. For a parent or guardian of a minor child that wishes to moderate the child's access, a business rule can be set that prior to a profile being accepted for the minor's Instant Messenger/Browser, the parent receives a listing of the sites and profile name to be created or edited. After the parent is validated, he/she can approve, edit or deny the selection.

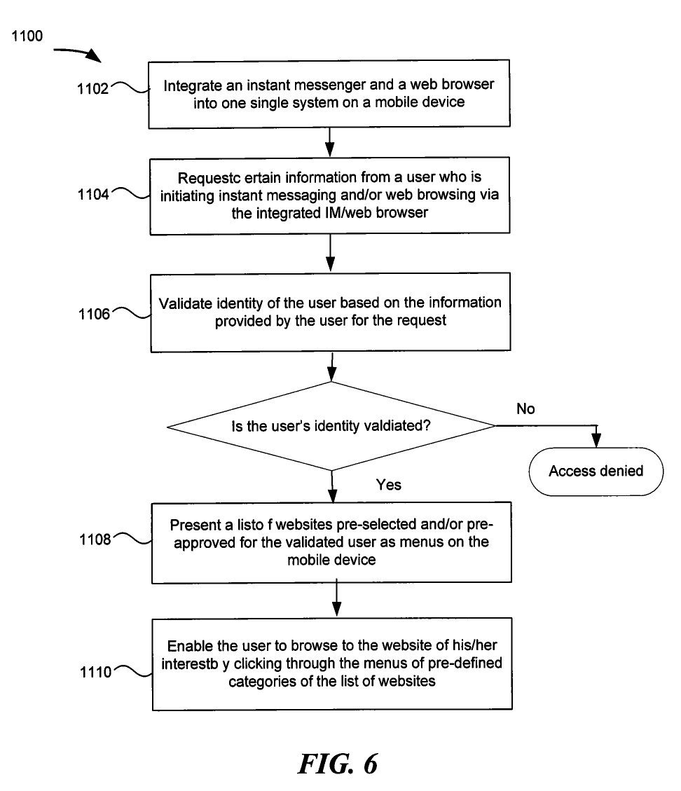

FIG. 6 depicts a flowchart of an example of a process to support controlled content access on mobile devices. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

According to FIG. 6, the flowchart 1100 starts at block 1102 where an instant messenger and a web browser are integrated into one system on a mobile device. The flowchart 1100 continues to block 1104 where certain information is requested from a user who is initiating instant messaging and/or web browsing via the integrated IM/web browser. The flowchart 1100 continues to block 1106 where identity of the user is validated based on information and/or answers provided by the user. If the identity of the user cannot be verified, access to IM or web content is denied. Otherwise, the flowchart 1100 continues to block 1108 where a list of websites pre-selected and/or pre-approved for the validated user is presented to the user as menus on the mobile device. The flowchart 1100 ends at block 1110 when the user is enabled to click through the menus of pre-selected/pre-defined categories to browse to the website of his/her interest. It is understood that the variations described above herein remain unaffected and also apply to flowchart 1100.

According to embodiments, integrated instant messaging and browsing system 105 works in conjunction with existing instant messaging servers 300 and web servers 200. Thus, communications networks need not install any additional server software because integrated instant messaging and web browsing system 105 seamlessly connects to existing instant messaging servers 300 and web servers 200. In addition, the instant messaging servers 300 may monitor and filter instant messages sent by the user to maintain proper information exchange between the users.

Integrated instant messaging and web browsing system 105 may either be preloaded on mobile device 100 at part of the operating system, embedded on a chip contained within mobile device 100 (i.e., be “embedded”), or as an add-on program application. Users 400 may also download and install integrated instant messaging and web browsing system 105, according to embodiments.

According to embodiments, communications between the website browser module 130 and web servers 200 is performed using the Hypertext Transfer Protocol (HTTP). Accordingly, other protocols are similarly contemplated, according to embodiments including, DHCP, DNS, FiP, IMAP4, IRC, MIME, POP3, SIP, SMTP, SNMP, SSH, TELNET, H'TTP, HUTS, BGP, RPC, RTP, RTCP, TLS/SSL, SDP, SOAP, L2TP, PPTP, and others known and understood by artisans, according to embodiments. According to embodiments, website browser module 130 communicates with web servers 200 via TCP internet protocol, which in turn can operate over any of several types of physical networks, including cellular phone networks. Other communications protocols are likewise contemplated according to embodiments, such as TCP, TCP/IP, UDP, DCCP, SCTP, GTP, WAP Datagram protocol, and others that would be known and understood by artisans.

According to embodiments, communications between the instant messaging module 120 and instant messaging server 300 is performed using the Extensible Messaging and Presence Protocol (XMPP), according to embodiments. Other instant messaging protocols are likewise contemplated, including Gadu-Gadu, Cspace, IRC, Meca Network, MSNP, OSCAR, Protocol for Synchronous Conferencing, TOC, TOC2, SIP/SIMPLE, Yahoo Messenger, DirectNet, XMPP, Zephyr Notification, Gale, Skype, and combinations thereof, according to embodiments. Instant messaging module 120 also operates over the TCP Internet Protocol, according to embodiments, and may also operate over any of several types of physical networks as previously described. Other communications protocols are likewise contemplated according to embodiments, such as TCP, TCP/IP, UDP, DCCP, SCTP, GTP, WAP Datagram protocol, and others that would be known and understood by artisans.

The integrated instant messaging and web browsing system 105 and method herein may be described in the general context of computer-executable instructions, such as program modules, being executed by a computer. Generally, program modules include routines, programs, objects, components, data structures, etc. that perform particular tasks or implement particular abstract data types. The system may also be practiced in distributed computing environments where tasks are performed by remote processing devices that are linked through a communications network. In a distributed computing environment, program modules may be located in both local and remote computer storage media including memory storage devices. The computer programs are stored in a memory medium or storage medium or they may be provided to a processing unit through a network or I/O bus.

In one aspect, integrated instant messaging and web browsing system 105 disclosed includes at least one central processing unit (CPU) or processor. The CPU can be coupled to a memory, ROM or computer readable media containing the computer-executable instructions for generating and using fingerprints for integrity management. Computer readable media can be any available media that can be accessed by the system and includes both volatile and nonvolatile media, removable and non-removable media implemented in any method or technology for storage of information such as computer readable instructions, data structures, program modules or other data. Computer storage media includes, but is not limited to, RAM, ROM, EEPROM, flash memory, portable memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the fingerprint generation and matching systems. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared, and other wireless media. Combinations of any of the above should also be included within the scope of computer readable media. The computer readable media may store instructions or data which implement all or part of the system described herein.

While the apparatus and method have been described in terms of what are presently considered to be the most practical and effective embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A system, comprising:
an integrated instant messaging and web browsing system deployed as a single application on a mobile device, wherein the integrated system comprises at least:
an instant messenger for sending and receiving instant messages;
a web browser for viewing web content over internet;
a display and control module, which while in operation,
requests information for validation of identity of a user who is initiating access to instant messaging and/or web browsing via the integrated instant messenger/web browser;
presents a list of websites pre-selected and/or pre-approved for the user on the mobile device if the identity of the user is validated;
enables the user to browse to a website of his/her interest through the list of websites;
an identity validation module, which while in operation, validates the identity of the user based on the information provided by the user.

2. The system of claim 1, wherein:
the display and control module requests additional information to be verified by a parent or guardian if the user is a minor.

3. The system of claim 1, wherein:
the list of websites is pre-selected and/or pre-approved by the user, parent or guardian of the user, and/or a carrier for the mobile device.

4. The system of claim 1, wherein:
the display and control module organizes the list of websites into one or more pre-defined click-through menus.

5. The system of claim 1, wherein:
the display and control module only allows the list of pre-selected and/or pre-approved websites to be presented to the user.

6. The system of claim 1, wherein:
the display and control module enables the user to create and select a profile to access to one or more websites of the user's interest.

7. The system of claim 1, further comprising:
a credit reporting module, which while in operation, generates a set of knowledge based authentication (KBA) questions based on credit and/or transaction history of the user for the validation of the identity of the user;
a credit database coupled to the credit reporting engine, wherein the credit database stores and manages credit and/or transaction history of the user.

8. The system of claim 7, wherein:
the identity validation module provides the set of KBA questions to and retrieve responses to the set of KBA questions from the user.

9. The system of claim 8 wherein:
the credit reporting module grades the responses to the set of KBA questions from the user.

10. The system of claim 9, wherein:
the identity validation module approves or denies the identity of the user based on the grading of the responses to the set of KBA questions from the user.

11. The system of claim 8, wherein:
the identity validation module denies the validation of the identity of the user if the user does not respond to the KBA questions in a timely manner.

12. The system of claim 1, wherein:
the identity validation module enables the user to register securely and to create a profile, one or more of a set of personal challenge questions (PCQs), and first answers to the PCQs when the identity of the user is validated.

13. The system of claim 12, wherein:
the display and control module presents the user with one or more of the set of PCQs when the user initiates a subsequent access to instant messaging and/or web browsing via the integrated instant messenger/web browser and accepts second answers to the one or more PCQs from the user.

14. The system of claim 13, wherein:
the identity validation module compares the first and the second answers to the one or more PCQs from the user to grant or decline the subsequent access.

15. A mobile device comprising:
a processor;
a memory;
a network connection; and
an integrated instant messaging and web browsing system executable by the processor for:
requesting information for validation of identity of a user who is initiating access to instant messaging and/or web browsing via the integrated instant messenger/web browser;
presenting a list of websites pre-selected and/or pre-approved for the user on the mobile device if the identity of the user is validated;
enabling the user to browse to a website of his/her interest through the list of websites.

16. The mobile device of claim 15, wherein:
the integrated instant messaging and web browsing system enables the user to receive instant messages, send instant messages, and views the website simultaneously.

17. A method, comprising:
integrating an instant messenger and a web browser into one single system on a mobile device;
requesting information from a user who is initiating access to instant messaging and/or web browsing via the integrated instant messenger/web browser;
validating identity of the user based on the information provided by the user;
presenting a list of websites pre-selected and/or pre-approved for the user on the mobile device if the identity of the user is validated;
enabling the user to browse to a website of his/her interest by clicking through one or more menus of pre-defined categories of the list of websites.

18. The method of claim 17, further comprising:
requesting additional information to be verified by a parent or guardian if the user is a minor.

19. The method of claim 17, further comprising:
pre-selecting and/or pre-approving the list of websites by the user, parent or guardian of the user, and/or a carrier for the mobile device.

20. The method of claim 17, further comprising:
organizing the list websites into one or more pre-defined click-through menus.

21. The method of claim 17, further comprising:
allowing only the list of pre-selected and/or pre-approved websites to be presented to the user.

22. The method of claim 17, further comprising:
enabling the user to create and select a profile to access to one or more websites of the user's interest.

23. The method of claim 17, further comprising:
generating a set of knowledge based authentication (KBA) questions based on credit and/or transaction history of the user for the validation of the identity of the user;
providing the set of KBA questions to and retrieving responses to the set of KBA questions from the user;
grading the responses to the set of KBA questions from the user;
approving or denying the identity of the user based on the grading of the responses to the set of KBA questions from the user.

24. The method of claim 23, further comprising:
denying the validation of the identity of the user if the user does not respond to the KBA questions in a timely manner.

25. The method of claim 17, further comprising:
enabling the user to access the web service and to create a profile, a set of personal challenge questions (PCQs), and first answers to the PCQs if the identity of the user is validated.

26. The method of claim 25, further comprising:
presenting the user with one or more of the set of PCQs when the user initiates a subsequent access to instant messaging and/or web browsing via the integrated instant messenger/web browser and accepting second answers to the one or more PCQs from the user.

27. The method of claim 26, further comprising:
comparing the first and the second answers to the one or more PCQs from the user to grant or decline the subsequent access.
